(19) United States
(12) Patent Application Publication
(10) Pub. No.: US 2006/0055532 A1
(43) Pub. Date: Mar. 16, 2006

(54) System and method for reporting lost baggage in real time

(75) Inventor: Gino Li, Sindian City (TW)

Correspondence Address: BACON & THOMAS, PLLC, 625 SLATERS LANE, FOURTH FLOOR, ALEXANDRIA, VA, 22314, US

(73) Assignee: Gino LI, Sindian City (TW)

(21) Appl. No.: 11/091,622

(22) Filed: Mar. 29, 2005

(30) Foreign Application Priority Data
Aug. 31, 2004 (TW) 093126182

(51) Int. Cl. G08B 1/08; H04Q 7/38; G08B 13/14

(52) U.S. Cl. 340/539.32; 455/414.1; 340/571

(57) ABSTRACT

A method and system for reporting lost baggage in real time is capable of rapidly finding a lost baggage for a passenger. A service station provides a 24-hour service phone number. A baggage tag is attached onto the passenger's checked baggage. The 24-hour service phone number of the service station, and a mobile phone number and a passenger name provided by a passenger are imprinted onto the baggage tag. When the baggage is lost, the mobile phone is turned on to receive a call form the service station for the lost baggage, and the service station receives a call with the 24-hour service phone number on finding the lost baggage and records the mobile phone number and the passenger name on the baggage tag of the lost baggage, so as to call the mobile phone according to the mobile phone number about the lost baggage.

### BACKGROUND OF THE INVENTION

1. Field of the Invention

The present invention relates to a system and method for reporting lost baggage in real time, which is capable of rapidly finding a lost baggage for a passenger having a mobile phone and traveling by an airplane.

2. Description of the Related Art

Because of the rush in modern life, people frequently make use of various means of transportation to travel to different destinations. When people travel by airplane they can carry only limited amounts of baggage with them in the seating areas, and so the passengers must check in their larger pieces of baggage for shipment in a separate baggage compartment. However, due to complicated flight routes, passengers may need to transfer at several different airports in route from the point of origin to the destination, and so must also their baggage. But sometimes, due to flight delays, short transfer times, or operating errors, the checked baggage may not arrive with the passenger, or may be placed at the incorrect baggage claim, and so the passenger will be unable to find the baggage.

To avoid the above-mentioned problems, generally, the airline company gives a baggage tag to passengers when they check in their baggage, which has a serial number on it. When the baggage is lost, the airline staff or airport staff find the lost baggage, and they can track the passenger information according to the serial number on the baggage tag to return the baggage to the passenger. Additionally, the passenger may place a personal baggage tag on the baggage, which has his or her name, address, telephone number and other identifying information. So if the baggage is lost, when the airline staff or airport staff find the baggage, they can send the baggage back to the passenger according to the information on the personal tag.

However, most passengers travel for business or vacation reasons, and addresses written on the baggage tags are usually their home addresses, so that the passengers will be unable to get their baggage back on their trips. Moreover, even if the baggage is sent back to the correct address, the passenger may still be traveling or have been moved to another place and so cannot receive the baggage. Therefore, it is desirable to provide a system and method for reporting lost baggage in real time to mitigate and/or obviate the aforementioned problems.

### SUMMARY OF THE INVENTION

A main objective of the present invention is to provide a system and method for reporting lost baggage in real time.

According to an aspect of the present invention, there is provided a system for reporting lost baggage in real time, capable of rapidly finding a lost baggage for a passenger having a mobile phone and traveling by an airplane. The system comprises: a service station for providing a 24-hour service phone number; and a baggage tag for attaching onto the passenger's checked baggage, the 24-hour service phone number of the service station, and a mobile phone number and a passenger name provided by a passenger imprinted onto the baggage tag; wherein when the baggage is lost, the mobile phone is turned on to receive a call form the service station for the lost baggage, and the service station receives a call with the 24-hour service phone number on finding the lost baggage and records the mobile phone number and the passenger name on the baggage tag of the lost baggage, so as to call the mobile phone according to the mobile phone number about the lost baggage.

According to another aspect of the present invention, there is provided a method for reporting lost baggage in real time, capable of rapidly finding a lost baggage for a passenger having a mobile phone and traveling by an airplane. The method comprises the steps of: (A) attaching a baggage tag onto checked baggage, the baggage tag imprinted with a 24-hour service phone number of a service station and having a mobile phone number and a passenger name provided by the passenger; (B) turning on the mobile phone to receive a call form the service station for the lost baggage when the baggage is lost; (C) the service station receiving a call with the 24-hour service phone number on finding the lost baggage and recording the mobile phone number and the passenger name on the baggage tag of the lost baggage; and (D) the service station calling the mobile phone according to the mobile phone number about the lost baggage.

According to another aspect of the present invention, there is provided a system for reporting lost baggage in real time, capable of rapidly finding a lost baggage for a passenger having a mobile phone and traveling by an airplane. The system comprises: a service station for providing a 24 hour service phone number; a baggage tag for attaching onto the passenger's checked baggage, which is imprinted with the 24-hour service phone number of the service station and a serial number; and a cover imprinted with the 24-hour service phone number of the service station and the serial number, the cover being carried around by the passenger; wherein when the baggage is lost, the mobile phone is turned on to make a call to the service station according to the 24-hour service phone number imprinted on the cover to provide the serial number and corresponding mobile phone number of the mobile phone for being recorded, and the service station receives a call with the 24-hour service phone number on finding the lost baggage and records the serial number on the baggage tag, so as to call the mobile phone about the lost baggage according to the mobile phone number corresponding to the serial number.

According to another aspect of the present invention, there is provided a method for reporting lost baggage in real time, capable of rapidly finding a lost baggage for a passenger having a mobile phone and traveling by an airplane. The method comprises the steps of: (A) attaching a baggage tag onto checked baggage, the baggage tag imprinted with a 24-hour service phone number of a service station and a serial number, wherein the baggage tag is associated with a cover imprinted with the 24-hour service phone number of the service station and the serial number, and the cover is carried by the passenger; (B) when the baggage is lost, turning on the mobile phone to make a call to the service station according to the 24-hour service phone number imprinted on the cover to provide the serial number and corresponding mobile phone number of the mobile phone for being recorded; (C) the service station receiving a call with the 24-hour service phone number on finding the lost baggage and records the serial number on the baggage tag; and (D) the service station making a voice call or sending a message to the mobile phone about the lost baggage according to the mobile phone number corresponding to the serial number, so as to obtain a current location of the passenger and inform an airline company to send the baggage to the passenger.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a system for reporting lost baggage in real time according to the present invention.

FIG. 2 is a schematic drawing of a first embodiment of a baggage tag according to the present invention.

FIG. 3 is a flowchart of a first embodiment of the method for reporting lost baggage in real time according to the present invention.

FIG. 4 is a schematic drawing of a second embodiment of a baggage tag according to the present invention.

FIG. 5 is a flowchart of a second embodiment of the method for reporting lost baggage in real time according to the present invention.

### DETAILED DESCRIPTION OF THE PREFERRED EMBODIMENT

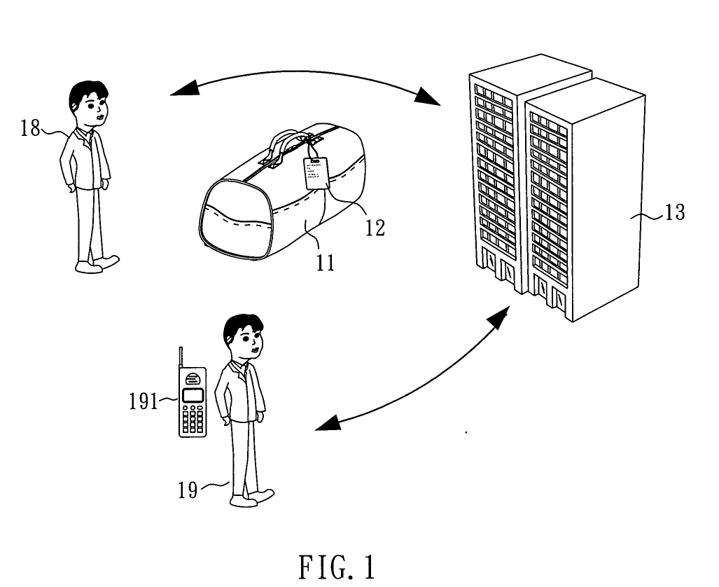

Please refer to FIG. 1. FIG. 1 is a schematic drawing of a system for reporting lost baggage in real time according to the present invention. Checked baggage 11 has attached to it a baggage tag 12; when the baggage 11 is lost, information provided on the baggage tag 12 can help a service station 13, airline staff 18 and a passenger 19 to find the baggage 11 in an interactive manner.

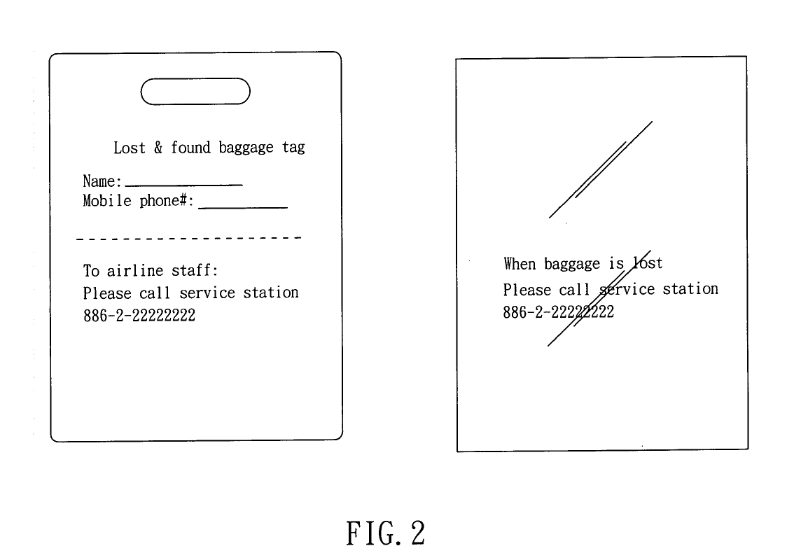

FIG. 2 is a schematic drawing of a first embodiment of a baggage tag according to the present invention. The baggage tag 12 has imprinted upon it a 24-hour service phone number (for example: 886-2-22222222) of the service station 13. Generally, when the passenger 19 gives the baggage to the airline company, the company gives the baggage tag 12 to the passenger 19 to fill out to provide his or her name and mobile telephone number. The baggage tag 12 is associated with a cover 21 which also has imprinted upon it the 24-hour service phone number of the service station 13 and is substantially the same size as a boarding card to hold the boarding card and be carried by the passenger.

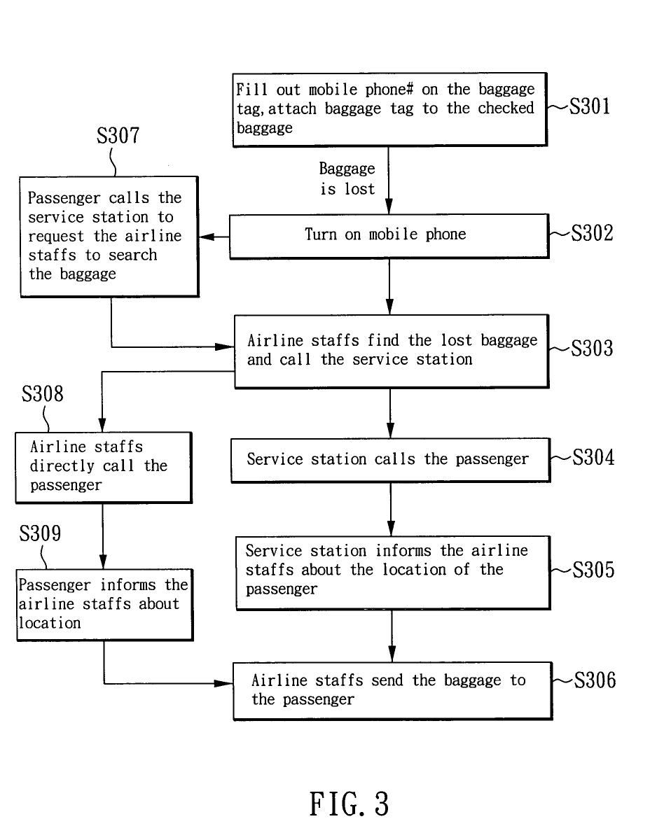

FIG. 3 is a flowchart of a first embodiment of the method for reporting lost baggage in real time according to the present invention. Please also refer to FIG. 1. The baggage tag 12 with the imprinted 24-hour service phone number, and mobile phone number and name provided by the passenger 19 is tied onto the baggage 12 which is checked in for shipping (step S301). When the passenger 19 arrives at his or her destination and cannot find the baggage 11, he or she turns on his or her mobile phone 191 to wait for information about the lost baggage 11 (step S302). When the airline staff 18 find the lost baggage 11 and call the service station according to the 24-hour service phone number on the baggage tag 12, the service station 13 records the mobile phone number and name imprinted on the on the baggage tag 12 (step S303) and makes a voice call or sends a message to the mobile phone 191 of the passenger 19 (step S304) to obtain the current location (such as the airport or hotel where the passenger currently stays) of the passenger 19 and inform the airline company (step S305) to send the baggage 11 to the passenger 19 (step S306).

Furthermore, the passenger 19 can obtain the 24-hour service phone number of the service station 13 on the cover 21; when he or she determines that the baggage 11 is lost, he or she turns on the mobile phone 191 (step S302) and calls the service station 13 to provide information about the baggage 11 to inform the airline company to begin searching for the lost baggage 11 (step S307).

When the airline staff 18 find the lost baggage 11 (step S303), according to the mobile phone number and name on the baggage tag 12, the airline staff 18 can call the passenger 19 directly (step S308) to obtain a current location (such as the airport or hotel where the passenger currently stays) of the passenger 19 (step S309) so as to return the baggage 11 to the passenger 19 (step S306).

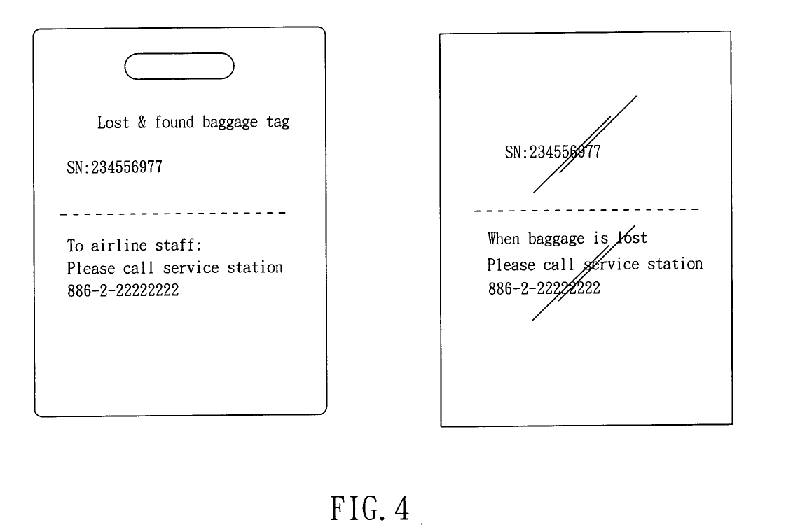

Please refer to FIG. 4. FIG. 4 is a schematic drawing of a second embodiment of a baggage tag according to the present invention. The baggage tag 12 has imprinted upon it the 24-hour service phone number of the service station and a serial number for the baggage 11. The baggage tag 12 is provided by the airline company, and is associated with a cover 21. The cover 21 also has imprinted upon it the 24-hour service phone number of the service station and the same serial number, and has substantially the same size as a typical boarding card so that the passenger 19 can put the boarding card in the cover 21 to carry them both around.

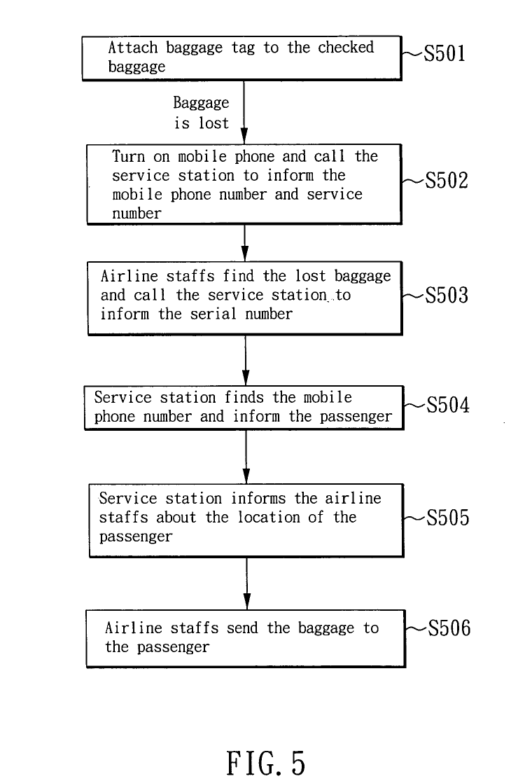

Please refer to FIG. 5. FIG. 5 is a flowchart of a second embodiment of the method for reporting lost baggage in real time according to the present invention. As shown in FIG. 5, the passenger 19 ties the baggage tag 12 with the imprinted 24-hour service phone number of the service station 13 onto the baggage 11 and checks in the baggage 11 (step 501). When the passenger arrives at his or her destination and is unable to find the baggage 11, he or she turns on the mobile phone 191 and calls the 24-hour service phone number on the cover 21 to provide a contact number (for example, a mobile phone number or a hotel phone number) and the serial number of the baggage 11 (step S502). Meanwhile, when the airline staff 18 find the lost baggage 11, they call the 24-hour service phone number on the baggage tag 12 and provide the serial number on the baggage tag 12 (step S503) so that the service station can find the corresponding contact number of the passenger 19 according to the serial number to call the passenger 19 (step S504) and obtain a current location (such as the airport or hotel where the passenger currently stays) of the passenger 19, and then provide this information to the airline company (step S505) to return the baggage 11 to the passenger 19 (step S506).

In view of the foregoing, it is known that the present invention provides the baggage tag with the imprinted 24-hour service phone number of the service station 13 and the passenger's mobile phone number so that the service station can be informed about the baggage's status and the passenger's current location to rapidly and correctly send the lost baggage back to the passenger.

Although the present invention has been explained in relation to its preferred embodiment, it is to be understood that many other possible modifications and variations can be made without departing from the spirit and scope of the invention as hereinafter claimed.

What is claimed is:

1. A system for reporting lost baggage in real time, capable of rapidly finding a lost baggage for a passenger having a mobile phone and traveling by an airplane, the system comprising:
a service station for providing a 24-hour service phone number; and
a baggage tag for attaching onto the passenger's checked baggage, the 24-hour service phone number of the service station, and a mobile phone number and a passenger name provided by a passenger imprinted onto the baggage tag;
wherein when the baggage is lost, the mobile phone is turned on to receive a call form the service station for the lost baggage, and the service station receives a call with the 24-hour service phone number on finding the lost baggage and records the mobile phone number and the passenger name on the baggage tag of the lost baggage, so as to call the mobile phone according to the mobile phone number about the lost baggage.

2. The system as claimed in claim 1, wherein the service station makes a voice call or sends a message to the mobile phone to obtain a current location of the passenger and provides corresponding information to an airline company to send the baggage back to the passenger.

3. The system as claimed in claim 1, wherein the baggage tag is associated with a cover upon for being carried by the passenger, and the cover is imprinted the 24-hour service phone number of the service station.

4. The system as claimed in claim 3, wherein the cover has substantially the same size as a boarding card.

5. The system as claimed in claim 3, wherein when the baggage is lost, the passenger calls the 24-hour service phone number of the service station to inform the service station about the lost baggage.

6. The system as claimed in claim 1, wherein when the baggage is lost, the mobile phone is turned on to receive a call on finding the lost baggage directly from an airline company, so that the airline company finding the baggage can obtain a current location from the passenger and send the baggage back to the passenger.

7. A method for reporting lost baggage in real time, capable of rapidly finding a lost baggage for a passenger having a mobile phone and traveling by an airplane, the method comprising the steps of:
(A) attaching a baggage tag onto checked baggage, the baggage tag imprinted with a 24-hour service phone number of a service station and having a mobile phone number and a passenger name provided by the passenger;
(B) turning on the mobile phone to receive a call form the service station for the lost baggage when the baggage is lost;
(C) the service station receiving a call with the 24-hour service phone number on finding the lost baggage and recording the mobile phone number and the passenger name on the baggage tag of the lost baggage; and
(D) the service station calling the mobile phone according to the mobile phone number about the lost baggage.

8. The method as claimed in claim 7, wherein in step (D), the service station makes a voice call or sends a message to the mobile phone to obtain a current location of the passenger and provides corresponding information to an airline company to send the baggage back to the passenger.

9. The method as claimed in claim 8, wherein in step (A) the baggage tag is associated with a cover for being carried by the passenger and the cover is imprinted with the 24-hour service phone number of the service station.

10. The method as claimed in claim 9, wherein the cover has substantially the same size as a boarding card.

11. The method as claimed in claim 9, wherein step (B) further comprises the step of: the passenger calling the 24-hour service phone number of the service station to inform the service station about the lost baggage.

12. The method as claimed in claim 7, wherein in step (B), the mobile phone receiving a call on finding the lost baggage directly from an airline company, so that the airline company finding the baggage can obtain a current location from the passenger and send the baggage back to the passenger.

13. A system for reporting lost baggage in real time, capable of rapidly finding a lost baggage for a passenger having a mobile phone and traveling by an airplane, the system comprising:
a service station for providing a 24 hour service phone number;
a baggage tag for attaching onto the passenger's checked baggage, which is imprinted with the 24-hour service phone number of the service station and a serial number; and
a cover imprinted with the 24-hour service phone number of the service station and the serial number, the cover being carried around by the passenger;
wherein when the baggage is lost, the mobile phone is turned on to make a call to the service station according to the 24-hour service phone number imprinted on the cover to provide the serial number and corresponding mobile phone number of the mobile phone for being recorded, and the service station receives a call with the 24-hour service phone number on finding the lost baggage and records the serial number on the baggage tag, so as to call the mobile phone about the lost baggage according to the mobile phone number corresponding to the serial number.

14. The system as claimed in claim 13, wherein the service station makes a voice call or sends a message to the mobile phone to obtain a current location of the passenger and informs an airline company to send the baggage to the passenger.

15. The system as claimed in claim 13, wherein the cover has substantially the same size as a boarding card.

16. A method for reporting lost baggage in real time, capable of rapidly finding a lost baggage for a passenger having a mobile phone and traveling by an airplane, the method comprising the steps of:
(A) attaching a baggage tag onto checked baggage, the baggage tag imprinted with a 24-hour service phone number of a service station and a serial number, wherein the baggage tag is associated with a cover imprinted with the 24-hour service phone number of the service station and the serial number, and the cover is carried by the passenger;
(B) when the baggage is lost, turning on the mobile phone to make a call to the service station according to the 24-hour service phone number imprinted on the cover to provide the serial number and corresponding mobile phone number of the mobile phone for being recorded;
(C) the service station receiving a call with the 24-hour service phone number on finding the lost baggage and records the serial number on the baggage tag;
(D) the service station making a voice call or sending a message to the mobile phone about the lost baggage according to the mobile phone number corresponding to the serial number, so as to obtain a current location of the passenger and inform an airline company to send the baggage to the passenger.
